(19) United States
(12) Patent Application Publication
(10) Pub. No.: US 2005/0248913 A1
(43) Pub. Date: Nov. 10, 2005

(54) Notebook computer case with internal suspension system

(76) Inventors: Eric S. Hassett, Golden, CO (US); Mark E. Phillips, Thornton, CO (US); Paul Fair, Denver, CO (US); Anthony K. Santillanes, Loveland, CO (US)

Correspondence Address: SHERIDAN ROSS PC, 1560 BROADWAY, SUITE 1200, DENVER, CO, 80202, US

(21) Appl. No.: 10/772,145

(22) Filed: Feb. 3, 2004

Related U.S. Application Data
(60) Provisional application No. 60/444,774, filed on Feb. 3, 2003.

(51) Int. Cl. G06F 1/16

(52) U.S. Cl. 361/683

(57) ABSTRACT

The present invention relates to a carrying case with an internal suspension system which is provided to reduce acceleration, shock, and the vibrational loads on an electronic device positioned within by placing the suspension system in a state of constant tension.

This application claims priority to pending U.S. provisional patent application Ser. No. 60/444,774 which was filed on Feb. 3, 2003 and is incorporated herein in its entirety by reference.

### FIELD OF THE INVENTION

The present invention relates to carrying cases for delicate or fragile articles such as notebook computers and other electronic equipment, and more specifically an integral shock absorption system adapted to protect articles from acceleration, shock, and vibrational loads to prevent damage during transportation and storage.

### BACKGROUND OF THE INVENTION

Electronic devices such as notebook computers, DVD players, radio equipment, and other similar non-electronic products such as survey equipment are very susceptible to acceleration and shock loads due to their internal circuitry and delicate componentry. As referred to herein, these devices are collectively called “electronic devices.” These types of devices are frequently hand carried or transported via automobile, train, aircraft, etc. to perform everyday tasks and are prone to damage in the form of acceleration, shock, or vibration loading which can occur when the devices are impacted, dropped, or transported. Previous methods of protecting notebook computers have generally utilized the addition of padding materials such as foam and rubber positioned within the lateral edges or on the bottom of a typical notebook carrying case or attache. Although padding may be helpful as a protective cushioning, the majority of shock loads from a dropped carrying case may still be transmitted to the electronic device due to the compressibility of the padding. In addition, padding materials are quite ineffective from protecting an article from acceleration loads, since the load will be transmitted in the same fashion as shock loads.

Isolation of an article generally provides an improved means of protection. Isolation can come in the form of a separate padded compartment in a carrying case which is attached to a wall of the carrying case with a flexible material that acts as a spring to dampen shock and acceleration forces originating from the outside of the case or as a result of the carrying case being dropped or impacted. An ideal carrying case thus supports the electronic device in all six possible degrees of travel, but systems of this type are generally too complicated and large to be economically feasible to manufacture or carry. Thus, there is a significant need for an affordable shock resistant attache or carrying case for delicate articles such as electronic componentry that can restrain and protect the delicate electronic componentry from damage during impact or as a result of acceleration loading.

One prior art method of isolating a notebook computer is to add an isolated compartment to a carrying case. The compartments allow the notebook computer to be slid into the case and be oriented such that the bottom of the computer is at or near parallel with the bottom of the case, and thus suspended above a bottom portion of the case. Generally, the compartment may be equipped with conventional foam or other padding materials to protect the electronic device. In addition, the bottom surface of the compartment may employ flexible fabrics to isolate the notebook computer from loads emanating from the bottom of the case due to a drop. However, no case currently exists which provides a means for protecting electronic componentry in a carrying case in substantially all six directions, nor provides any type of external viewing device which identifies the internal position of the electronic device positioned within the carrying case. Furthermore, no prior art storage devices are known to exist which store the electronic device within an internal suspension system which is preloaded and in tension when it is interconnected to the electronic device.

In view of the above, there is a long felt but unsolved need for a carrying case that isolates fragile electronic devices, such as notebook computers, in more than one direction, and that avoids the above-mentioned deficiencies of the prior art.

### SUMMARY OF THE INVENTION

Accordingly, it is one aspect of the present invention to provide a cost effective and portable carrying case which provides protection from acceleration and shock loads to an electronic device positioned within the carrying case. Thus, in one embodiment of the present invention a portable carrying case or attache is provided which has a separate compartment for holding electronic componentry and which has a suspension system to provide protection in a plurality of directions.

It is another aspect of the present invention to provide a compartment in a carrying case which is capable of providing protection to an electronic device in at least six directions or travel. More specifically, a combination of flexible materials and conventional padding may be used to absorb loads caused by impact from any direction or from dropping the case in a generally vertical direction. The advantage of this concept is that more protection is afforded to the carried item than in traditional cases which depend solely on padding for protection or limit the use of flexible materials for protection in limited directions. Further traditional cases do not protect electronic devices if the case is inadvertently tipped over or dropped on its upper surface.

It is yet another aspect of the present invention that, while the case affords more protection, it remains light weight. A shock absorbent or loads resistant case can be made of any number or combination of materials which will dictate the weight of the finished product. A substantially indestructible and protective shock absorbent or load resistant case would generally be not feasible to construct because of the significant weight and cost. Thus, materials that are preferably used to protect and isolate electronic devices are generally light, and more specifically, organic materials such as NYLON, TEFLON, elastic fiber, etc. are used. By altering the way these materials are used with each other, and with the addition of padding, an electronic device can be protected in substantially six directions of travel.

It is yet another aspect of the present invention that the compartment which holds the electronic device be expandible. By using flexible materials to isolate an electronic device from loads, an added advantage of expandability emerges. Some cases that do not use flexible materials, or limit their use, commonly have carrying compartments of fixed volumes. A user of a case with a fixed volume may be forced to buy a new case when purchasing a new electronic device. Electronic devices vary in size and shape, and a compartment that is compliant with different electronic devices is of great utility to a user.

It is a further aspect of the present invention to provide an internal suspension system which is placed in constant tension when retaining the electronic device. More specifically, in one embodiment of the present invention a flexible gusset material such as rubber is utilized which stretches and thus provides constant tension. By preloading the suspension system with the use of a retention strap or other device, it has been found that the electronic device is much less likely from contacting a lower compartment of the case, and thus substantially preventing impact damage. Further, the suspension system is effective even when the case is inadvertently inverted or dropped on its upper surface.

It is a further aspect of the present invention to provide an external indicator device on the exterior of the carrying case which indicates the relative amount of tension being applied to the internal suspension system. Thus, depending on what type of electronic device is being stored, a user can quickly identify the amount of tension provided on the electronic device within the carrying case. In one embodiment of the present invention, the external indicator device comprises a color coded mechanism which identifies the amount of vertical travel of the suspension system, or which alternatively has a mechanism which identifies a relative degree of vertical travel when viewed with respect to a stationary reference indicator. It is still a further aspect of the present invention that the carrying case and carrying compartment may be designed from inexpensive materials that are well-known in the art.

These include nylon, rubber, plastics and other similar materials which are generally flexible as opposed to rigid.

Thus, in one embodiment of the present invention a carrying case with an internal suspension system adapted for supporting and protecting an electronic device, comprising:
an enclosure defined by a front panel, a rear panel, a bottom panel, a top panel and opposing side panels;
a selective opening means interconnected to at least said top panel to allow access to an internal portion of said enclosure;
a support platform positioned within said internal portion of said enclosure and elevated above said bottom panel, said support panel adapted to support a notebook computer;
a first stretchable suspension cord operably engaged to said support platform and interconnected to one of said opposing side panels;
a second stretchable suspension cord operably engaged to said support platform and interconnected to an opposite end of said opposing side panels, wherein said support platform is biased from downward movement yet travels upwardly and downwardly within said enclosure, but is substantially impeded from contacting said bottom panel of said computer case.

### BRIEF DESCRIPTION OF THE DRAWINGS

FIG. 1 is a front elevation view of one embodiment of the present invention;

FIG. 2 is a cutaway front elevation view of the embodiment shown in FIG. 1, and identifying the internal components of the internal suspension system;

FIG. 3 is a rear elevation view of the embodiment shown in FIG. 1;

FIG. 4 is a right elevation view of the invention shown in FIG. 1, and depicting the external force indicator mechanism;

FIG. 5 is a front elevation view of an internal panel positioned within the carrying case shown in FIG. 1;

FIG. 6 is an alternative embodiment of an internal panel positioned within the invention shown in FIG. 1;

FIG. 7 is a front elevation view of an external force indicator device used in association with the carrying case depicted in FIG. 1; and

FIG. 8 is a front perspective view of an alternative embodiment of the present invention as positioned within an attache case.

### DETAILED DESCRIPTION

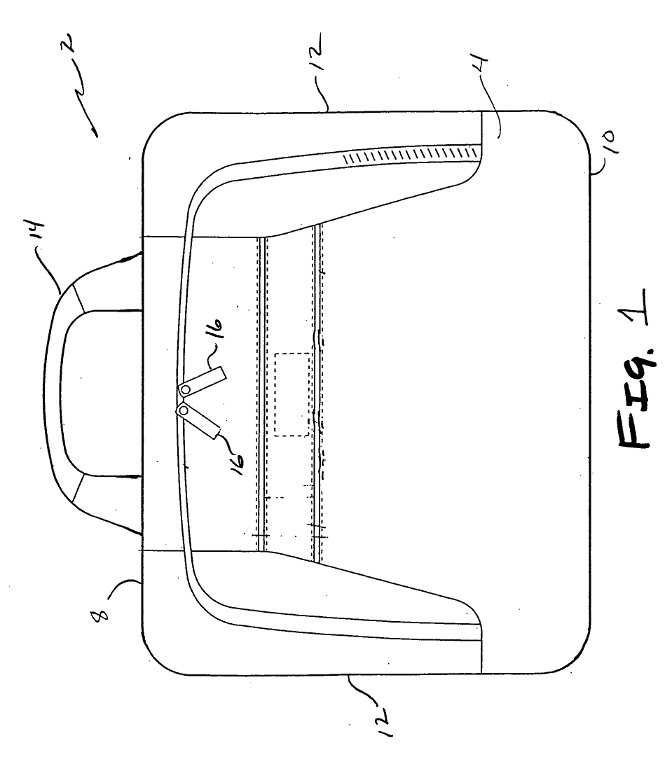

Referring now to the drawings, FIG. 1 depicts a front elevation view of one embodiment of the present invention. More specifically, the notebook computer case 2 generally comprises a front panel 4, a rear panel 6, a top panel 8, a bottom panel 10 and opposing side panels 12 positioned between the top panel 8 and the bottom panel 10. Although generally designed to carry a notebook computer, the carrying case 2 may be used to retain and safely store any type of electronic device which may be fragile and prone to breakage when being dropped or receiving an impact. The computer case 2 shown in FIG. 1 generally includes one or more openings which allow access to the computer case and insertion and removal of the electronic device. The opening may be selectively implemented with the use of one or more zippers 16, buckles, or other types of opening mechanisms commonly known in the art. Generally, the opening is included in the top panel 8, but the opening feature may also be positioned in the front panel 4, rear panel 6, or within one of the side panels 12.

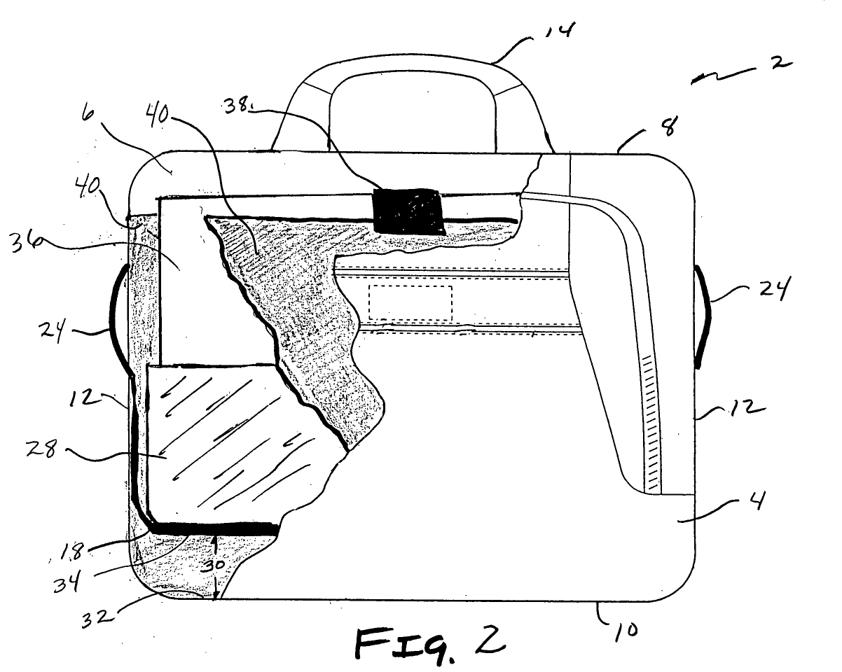

Referring now to FIG. 2, a front elevation view of the carrying case 2 depicted in FIG. 1 is provided in a cutaway view, and which more clearly identifies the various internal components of the present invention. More specifically, a storage compartment 28 is provided within the internal confines of the computer case 2, and which is sized to receive an electronic device. The storage compartment lower surface 34 is positioned above the carrying case inner bottom surface 32, which defines a gap 30 which is designed to retain the electronic device above the lower portion of the computer case 2. This gap 30 allows reciprocal travel of the storage compartment 28 within the computer case 2 by the use of one or more internal tension straps 24. The internal tension straps 24 are operably positioned or interconnected to the storage compartment 28, and are generally comprised of rubber, elastic, or other resilient materials which are capable of repeated stretching. Upon insertion of the electronic device into the storage compartment 28, the storage compartment 28 is allowed to travel upwardly and downwardly in a generally vertical motion defined between the bottom panel 10 and the top panel 8.

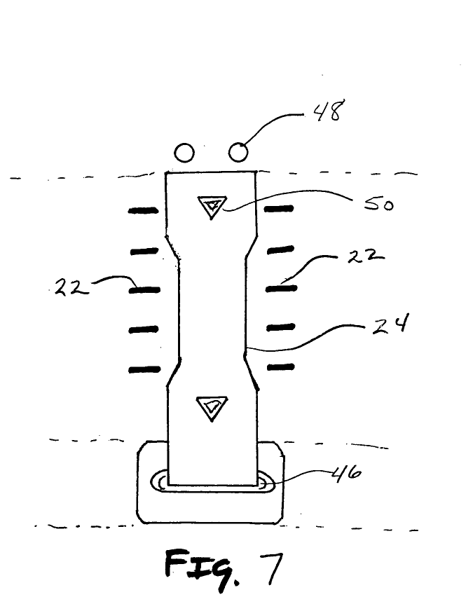

In a preferred embodiment of the present invention, and again referring to FIG. 2, an internal suspension strap 38 is provided which may include a Velcro strap, a buckle mechanism, or other common retention device known in the art which is designed to place the internal tension straps 24 in tension upon placement of the electronic device into the storage compartment 28. More specifically, the dimensions of the storage compartment 28 may generally be smaller than the size of an electronic device, and thus requires that the electronic device be pushed downward while securing the internal suspension strap 38. By providing constant tension on the internal tension strap 24, it has been found that the electronic device is protected from travel and subsequent impact in both a downward direction, upward direction and laterally within the storage compartment 28. As further shown in FIG. 2, the internal tension strap 24 preferably extends outside of the side panel 12 by means of a panel aperture 46. By securing the internal tension strap 24 on an exterior side panel 12, a force indicator 22 may be provided a shown in FIG. 7, and which shows relative travel of the internal tension strap 24, and thus the amount of loading on the internal storage compartment 28. Furthermore, by pre-loading the internal tension strap by placing it in tension, the storage compartment 28 has less room for travel and acceleration, and has been found to be much more effective.

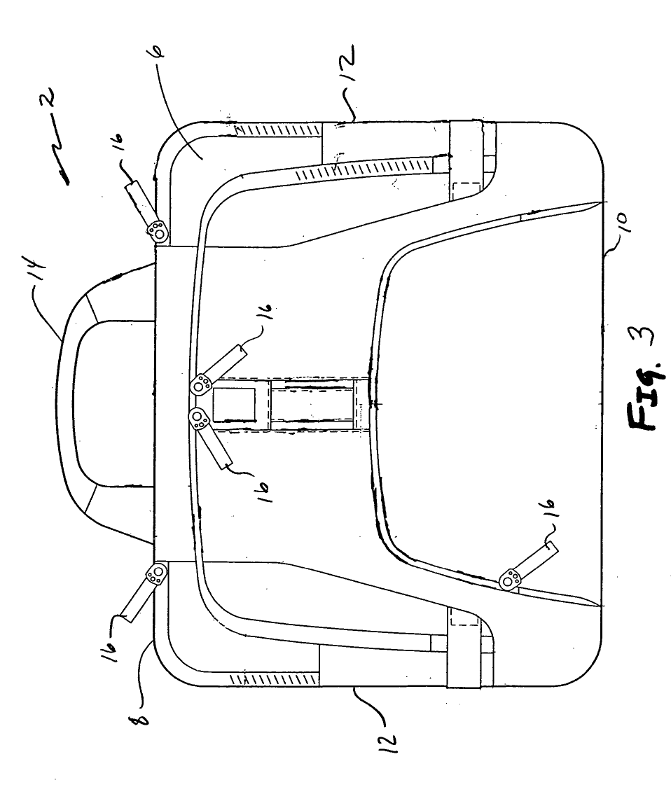

Referring now to FIG. 3, a rear elevation view of the notebook computer case 2 of the present invention is provided herein. More specifically, the rear panel 6 of the present invention may include one or more separate openings to provide storage for accessory items such as extension cords, compact discs, writing materials, telephones and other items commonly stored in an attache or briefcase. The openings to the rear panel 6, are generally facilitated with zippers 16, or any other opening means such as Velcro. Furthermore, a handle 14 may be positioned on the top panel 8, or in any other convenient location.

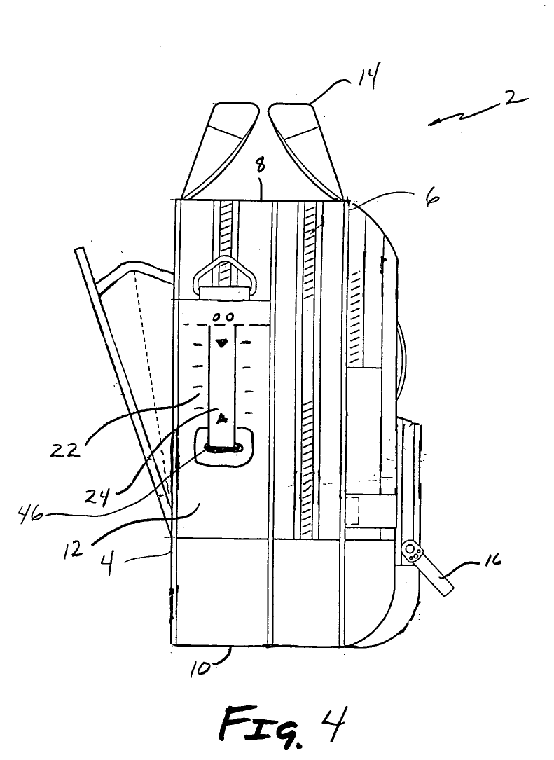

Referring now to FIG. 4, a right elevation view of the present invention is provided herein. More specifically, the internal tension strap 24 extending outwardly from a panel aperture 46 is shown, along with a force indicator 22 which in this embodiment is a plurality of vertical marks extending next to the internal tension strap 24. As appreciated by one skilled in the art, the force indicator may be a series of horizontal or vertical lines or any type of indicia which indicates vertical movement of the tension strap 24. As the electronic device is loaded in the storage compartment 28 and forced downwardly, the internal tension strap 24 moves downwardly in a generally vertical direction, and thus indicates the amount of tension being applied to the internal tension strap 24. Thus, a user is always mindful of the amount of loading and force being applied to the internal tension strap 24, and the relative size of the gap 30 between the carrying case inner bottom surface 32 and the storage compartment lower surface 34.

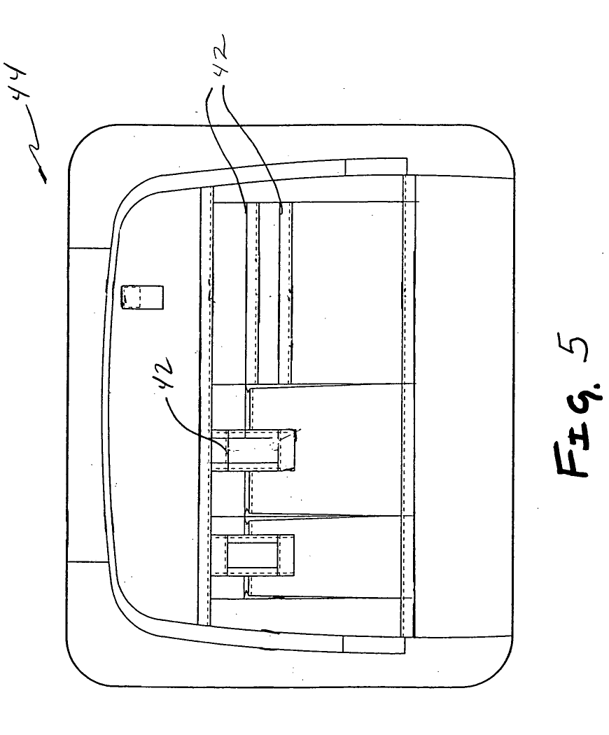

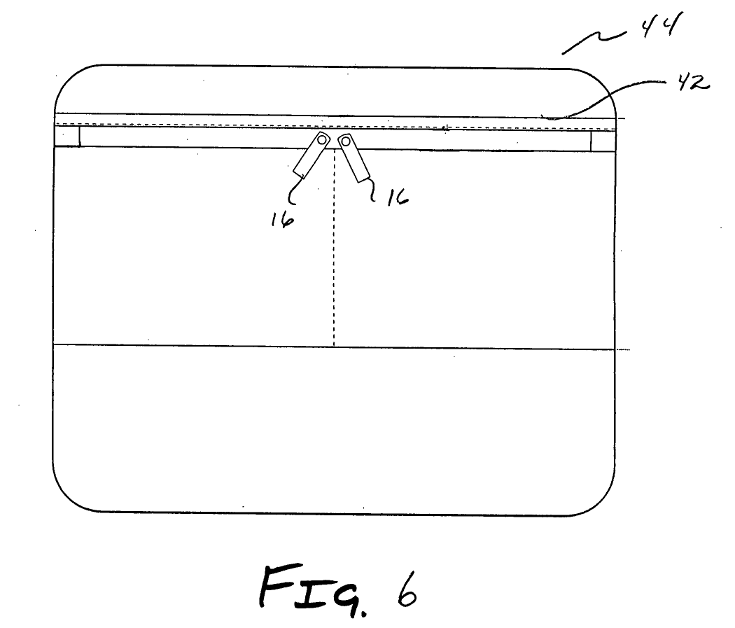

Referring now to FIG. 5, one embodiment of an internal panel positioned within the rear panel 6 of the present invention is provided herein. More specifically, one or more internal accessory compartments 42 are provided and may be used to secure pens, telephones, compact discs and DVDs and other materials commonly used with an attache or briefcase. With regard to FIG. 6, an alternative internal panel of the present invention is provided herein, and which may be included on either the interior of the front panel 4 or rear panel 6, or positioned there between as appreciated by one skilled in the art.

Referring now to FIG. 7, a front elevation view of the force indicator 22 of the present invention is provided herein. More specifically, the force indicator as shown in FIG. 4 is generally positioned on a side panel 12 of the computer case 2, but may be placed in other locations. By extending the internal tension strap 24 through the panel aperture 46, the internal tension strap 24 is easily viewed from an exterior of the computer case 2. As shown in FIG. 7, one end of the tension strap 24 is generally attached to the side panel 12 with one or more rivets 48 or other type of interconnection device. When the internal storage compartment 28 is loaded with an electronic device or other product, the internal tension strap 24 is stretched, moving the indicator arrows 50 in a downward direction, and thus identifying relative movement with respect to one or more force indicator marks 22. When loading is removed from the internal storage compartment 28, and tension is released from the internal tension strap 24, the indicator arrows 50 would generally move in an upward direction identifying that the loading has been reduced or eliminated.

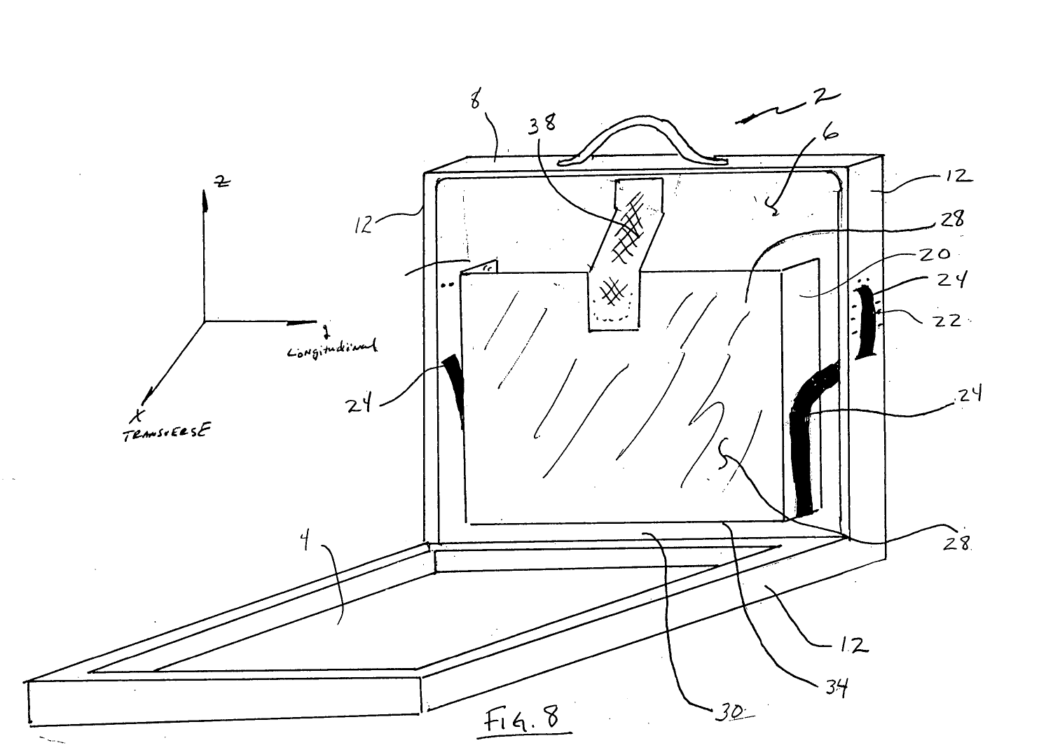

Referring now to FIG. 8, a front perspective view of an alternative embodiment of the present invention is provided, and more specifically showing the front panel 4 in an open position. As shown, the internal storage compartment 28 may include side panels which include suspension gussets 20 or other flexible materials which provide resilience if there is movement in a longitudinal or transverse direction. Furthermore, the internal tension strap 24 is shown positioned below the internal storage compartment 28, and which may be interconnected to a nylon, cloth, cotton or other non-stretchable material along the bottom surface of the storage compartment 28. Thus, it is not necessary for the entire portion of the internal tension strap 24 to be resilient, but only a portion which allows sufficient movement in the vertical or “Z” direction. Furthermore, an alternative type of internal suspension strap 38 is provided herein, and which may be interconnected to a rear panel 6 with hook and loop materials or other similar materials. In one embodiment of the present invention, it is anticipated that the internal suspension strap 38 also be comprised of a resilient elastic or rubber material which would provide tension to an electronic device and also provide additional padding when there is movement in the vertical or “Z” direction.

As further appreciated by one skilled in the art, internal padding materials may additionally be placed throughout the carrying case 2 to provide additional protection and support. More specifically, the back of the storage compartment is the existing rear panel of the case. Preferably, this wall is equipped with padding 40 to help dissipate energy that emanates from a rear direction. This rear panel 6 will be the attachment surface for at least three sides of the protective compartment. Flexible suspension gussets 20 are provided to interconnect the padded front panel 4 to the rear panel 6. These flexible suspension gussets 20 prevent damage when the carrying case 2 is dropped by allowing the flexible gussets 20 to absorb the acceleration energy of a moving electronic device. In addition, the flexible gussets 20 will help prevent the transmission of loads in a vertical or transverse direction.

As a further protective feature, a gap 30 is positioned between the inner bottom surface 32 of the carrying case and the bottom surface 34 of the storage compartment, so that an electronic device in the compartment does not impact the lower inner surface of the case if inadvertently dropped, and would deflect the suspension gussets 20 and dissipate the energy.

The nature of the invention can also be shown from the perspective of the article being carried. For example, an electronic device would be constrained in the positive transverse direction by the padded front panel 4 of the storage compartment 28, which in turn may be connected by flexible gussets to the padded rear panel 6. In the negative transverse direction 20, the electronic device is constrained by the padded rear panel. In the longitudinal direction the electronic device would be supported by the suspension flexible gussets 20. In the upward direction 27 the computer is supported by the suspension strap 38, and possibly other padding materials. Finally, in the downward direction, the computer may be supported by a padded bottom which is separated from the bottom inner surface of the case. Therefore, the computer is flexibly constrained in four and potentially six distinct directions of travel, including downward, upward, transversely, and laterally.

To assist in the understanding of the present invention the following list of components and associated numbering found in the drawings is provided herein:

| # | Component |
|---|---|
| 2 | Notebook computer case |
| 4 | Front panel |
| 6 | Rear panel |
| 8 | Top panel |
| 10 | Bottom panel |
| 12 | Side panel |
| 14 | Handle |
| 16 | Zipper |
| 18 | Support panel |
| 20 | Suspension gussets |
| 22 | Force indicator |
| 24 | Internal tension strap |
| 26 | Strap ring |
| 28 | Storage compartment |
| 30 | Gap |
| 32 | Carrying case inner bottom surface |
| 34 | Storage compartment lower surface |
| 36 | Electronic device |
| 38 | Internal suspension strap |
| 40 | Padding |
| 42 | Internal accessory compartments |
| 44 | Internal storage panel |
| 46 | Panel aperture |
| 48 | Rivets |

While various embodiment of the present invention have been described in detail, it is apparent that modifications and variations of those embodiments will occur to those skilled in the art. However, it is to be expressly understood that such modifications are within the scope and spirit of the present invention.

1. A notebook computer case with an internal shock suspension system, comprising:
an enclosure defined by a front panel, a rear panel, a bottom panel, a top panel and opposing side panels;
a selective opening means interconnected to at least one of said top panel, said front panel and said rear panel to allow access to an internal portion of said enclosure;
a support platform positioned within said internal portion of said enclosure and elevated above said bottom panel, said support panel adapted to support an electronics device;
a first stretchable suspension cord in operable contact with said support platform and interconnected to one of said opposing side panels;
a second stretchable suspension cord in operable contact with said support platform and interconnected to an opposite end of said opposing side panels, wherein said support platform is biased from downward movement and is substantially impeded from contacting said bottom panel of said computer case.

2. The notebook computer case of claim 1, wherein said first stretchable suspension cord and said second stretchable suspension cord are comprised from at least one of a rubber and an elastic material.

3. The notebook computer case of claim 1, further comprising a foam material interconnected to an internal surface of said front panel and said rear panel.

4. The notebook computer case of claim 1, wherein a second end of said first stretchable suspension cord and a second end of said second stretchable suspension cord are interconnected proximate to an outer surface of said opposing side panels.

5. The notebook computer case of claim 1, further comprising an indicator means interconnected to said first or said second stretchable suspension cord which identifies a relative amount of vertical travel of said support platform.

6. The notebook computer case of claim 5, wherein said indicator means has a first marker positioned on at least one of said first or said second stretchable suspension cords and a second marker positioned on at least one of said opposing side panels, wherein a distance between said first and said second marker identifies a relative amount of tension on said support panel.

7. The notebook computer case of claim 1, wherein said first and said second stretchable suspension cords are comprised of at least one of a rubber material and an elastic material.

8. The notebook computer case of claim 1, further comprising an internal strap mechanism interconnected to at least one of an upper end of said front panel and said rear panel, and which is adapted to secure the notebook computer and place said first and said second stretchable suspension cords in tension.

9. The notebook computer case of claim 1, wherein said support panel further comprises a cushioning layer.

10. A carrying case with an internal suspension system adapted for supporting and protecting an electronic device, comprising:
a first compartment comprising a top side, a bottom side, a front side, a rear side, and a pair of lateral sides;
an internal suspension system positioned within said first compartment comprising:
a) a support panel oriented substantially parallel to said bottom side of said first compartment;
b) a flexible suspension material operably engaged on a first end to said support panel, and interconnected on a second end to at least one of said pair of lateral sides, wherein said support panel travels upwards and downwardly within said first compartment; and
c) a strap in inoperable contact with said first compartment to secure the electronic device within the first compartment, and impart tension to said flexible suspension material, wherein the electronic device may be selectively inserted and removed from said internal suspension system by releasing or securing said strap.

11. The carrying case of claim 10, further comprising a handle interconnected to an exterior of said carrying case.

12. The carrying case of claim 10, wherein said flexible suspension material is comprised of at least one of an elastic material and a rubber material.

13. The carrying case of claim 10, wherein said carrying case is at least one of an attache, a piece of luggage, a purse, a backpack and a suitcase.

14. The carrying case of claim 10, wherein said flexible suspension material comprises a first rubber strap interconnected to one of said lateral sides, and a second rubber strap interconnected to an opposite one of said lateral sides.

15. The carrying case of claim 10, further comprising an external indicator device which is operably interconnected to said internal suspension system, wherein a visual indicator identifies the relative degree of loading imparted to said suspension system.

16. The carrying case of claim 10, wherein said flexible suspension material comprises a non-stretchable strap portion which extends below said support panel.

17. The carrying case of claim 10, wherein said support panel may be selectively removed from said carrying case.

18. A carrying case with an internal suspension system adapted to store an electronic device, comprising:
a front panel, a rear panel, a top panel, a bottom panel and opposing side panels;
an opening means interconnected to at least one of said front panel, said rear panel, said top panel and said opposing side panels;
an internal support panel positioned within said carrying case;
a biasing means operatively interconnected to said support panel and at least one of said opposing side panels, wherein said internal support panel is restrained from traveling toward said bottom panel;
a tension strap operatively interconnected to an internal portion of said carrying case which retains the electronic device within said carrying case and imparts tension to said biasing means, wherein said internal support panel travels in a substantially vertical direction between said top panel and said bottom panel; and
an external indicator means position on at least one of said side panels which identifies relative movement of said support panel when the electronic device is positioned on said internal support panel.

19. The carrying case of claim 18, wherein said biasing means comprises at least one rubber or elastic strap.

20. The carrying case of claim 18, wherein said support panel is suspended above an internal surface of said bottom panel a distance of at least about two inches.
